(19) United States
(12) Patent Application Publication
(10) Pub. No.: US 2016/0116896 A1
(43) Pub. Date: Apr. 28, 2016

(54) NUMERICAL CONTROL DEVICE

(71) Applicant: FANUC Corporation, Minamitsuru-gun (JP)

(72) Inventor: Yuuki OONISHI, Minamitsuru-gun (JP)

(21) Appl. No.: 14/918,778

(22) Filed: Oct. 21, 2015

(30) Foreign Application Priority Data
Oct. 22, 2014 (JP) 2014-215564

(51) Int. Cl. G05B 19/18; G05D 3/12

(52) U.S. Cl. CPC G05B 19/18; G05D 3/12

(57) ABSTRACT

A numerical control device for controlling a motor includes a stopping unit configured to stop the motor using position control gain for emergency stop corresponding to emergency stop command, wherein emergency stop of the motor is performed with position control.

### BACKGROUND OF THE INVENTION

1. Field of the Invention

The present invention relates to a numerical control device for controlling a motor, and more particularly to a numerical control device which shorten motor stopping distance.

2. Description of the Related Art

In machines driven by a motor such as machining tools or industry robots, there is a case where emergency stop of the driven machine is necessary in emergency stop state in which emergency stop button is pressed from demand of safety measure or alarm is generated.

For stopping the motor, the motor is stopped while motor control method is still position control in normal case, but in emergency such as a case where abnormality occurs, the motor control method is changed from the position control to speed control and zero speed is commanded, such that emergency stop is performed under speed control to make motor rotation speed to be zero by commanding zero speed. FIG. 1 is a diagram for explaining a prior art for stopping a motor. Speed control is performed for the motor rotation speed to be zero, and stopping distance is reduced compared to normal stopping distance.

Japanese Patent Laid-Open No. 7-143780 discloses a technique for performing emergency stop, in which, when a motor is urgently stopped by abnormality occurrence and the like, motor control method is switched from position control to speed control corresponding to emergency stop command, and motor rotation speed is controlled to be zero by speed control, and stopping distance is reduced compared to normal stopping distance.

There has been a problem for stopping position control in the prior art in which motor control method is switched from positon control to speed control corresponding to emergency stop command, since the speed command value of the motor become zero corresponding to the emergency stop command.

When the motor, in which the control method is switched to speed control, is driven again, servo position deviation amount, which is accumulated by movement from time when the position control is stopped, needs to be cleared, and the amount cleared needs to be reflected (hereinafter referred to as “follow-up”) to a current position managed by a numerical control device, leading to a cause for time loss from emergency stop to restart of operation. It should be noted that, when the control method is switched back to the position control without performing follow-up, it is dangerous since there is a possibility that the motor rapidly moves such that the servo position deviation amount is decreased to be zero.

In addition, stopping with short stopping distance is possible since the sopping is performed switching the motor control method from position control to speed control, but the switching causes the following new problem. When emergency stop command is executed during a plurality of motors are operating along commanded paths performing interpolation, position control is switched to speed control, and the plurality of motors individually urgently stop without keeping synchronization. As a result, the synchronization between the motors in position control is lost and the motors stop at positions deviated from commanded paths, causing continuation of machining and restarting of operation to be difficult, and possibility of generating non defective item.

### SUMMARY OF THE INVENTION

In view of the above-described problems in the prior art techniques, a purpose of the present invention is to provide a numerical control device, which acquires stopping characteristics of the motor by performing stopping with speed control in advance, calculates position control gain at emergency stop based on the acquired data, and switches normal gain to the high gain calculated for emergency stop at the emergency stop, urgently stops still with position control, and decreases stopping distance of the motor.

The numerical control device according to the present invention acquires stopping characteristic data of the motor by performs stopping with speed control in advance, and calculates position control gain at emergency stop based on the acquired data. At emergency stop, the normal gain is switched to the high gain calculated for emergency stop, and the motor urgently stops still with position control. The position control gain is a coefficient of response for position command, and higher responsivity for position control is obtained with higher gain value, but too high value of the gain causes unstable behavior.

A numerical control device according to the present invention is the numerical control device for controlling a motor, includes a stopping unit configured to stop the motor using position control gain for emergency stop corresponding to emergency stop command, wherein emergency stop of the motor is performed with position control.

The position control gain for emergency stop may be calculated based on speed at emergency stop and travel distance required for emergency stop when emergency stop is performed with speed control as motor control method in advance.

Command position may be changed to emergency stop position calculated from current speed and gain changed when the emergency stop command is output.

Nearest command position where a plurality of axes stop keeping synchronization may be output, when the emergency stop command is output during operation of the plurality of axes along commanded paths with interpolation, such that position relationship of the plurality of axes are kept at emergency stop.

A plurality of position control gain for emergency stop, each corresponds to a plurality of patterns with different conditions, may be kept, and position control gain for emergency stop corresponding to the condition is configured to selected at emergency stop.

The present invention, with the above configuration, can calculate appropriate position control gain to stop in the shortest distance at emergency stop. The position control gain is applied at emergency stop, so the emergency stop can be performed in the shortest distance without switching motor control method from position control to speed control. Therefore, the plurality of axes stop performing interpolation, and stopping can be performed keeping the synchronization among the axes. In addition to that, a set of operations, which is performed after emergency stop by switching to speed control, to clear the servo position deviation amount, reflect (follow-up) the cleared amount to the current position managed by the numerical control device, and return to position control from speed control, is not necessary, so the operation stop time from emergency stop to restarting of operation can be decreased.

### BRIEF DESCRIPTION OF THE DRAWINGS

The above-described object, the other object, and the feature of the invention will be proved from the description of embodiments below with reference to the accompanying drawings. In these drawings:

FIGS. 1A, 1B are diagrams for explaining a prior art for stopping a motor.

FIG. 2 is a diagram for explaining a motor is overshot and reversed with excessively high gain, thought high gain enables quick stop.

FIGS. 3A, 3B, 3C are diagrams for explaining control for switching to high gain and emergency stop.

FIG. 4 is a diagram showing a control device equipped with a unit for calculating position control gain for emergency stop.

FIG. 5 is a flowchart for explaining control for switching position control gain to position control gain for emergency stop which is calculated by conventional emergency stop (with speed control) in advance.

FIG. 6A is a diagram illustrating a case in which stop position is not changed when emergency stop is commanded, and FIG. 6B is a diagram illustrating a case in which stop position is changed when emergency stop is commanded.

FIG. 7 is a flowchart of control in which, when emergency stop command is executed, position control gain is switched to position control gain for emergency stop calculated by conventional emergency stop (with speed control) performed in advance, then emergency stop position is calculated based on current motor speed, and command position is changed to emergency stop position.

FIGS. 8A, B, C is a diagram illustrating control for determining emergency stop command position of each axis keeping position relationship among axes at emergency stop and stopping without deviating from commanded paths.

FIG. 9 is a flowchart illustrating a process of executing loop processing for all interpolating axes, changing position control gain for emergency stop to the same value of a reference axis except for the reference axis, and changing the stop position such that the axes can stop in command paths.

FIG. 10 is a diagram illustrating hot gear rolling of a spur gear machined by a plurality of axes.

FIG. 11 is a diagram illustrating a numerical control device with reduced stopping distance of a motor.

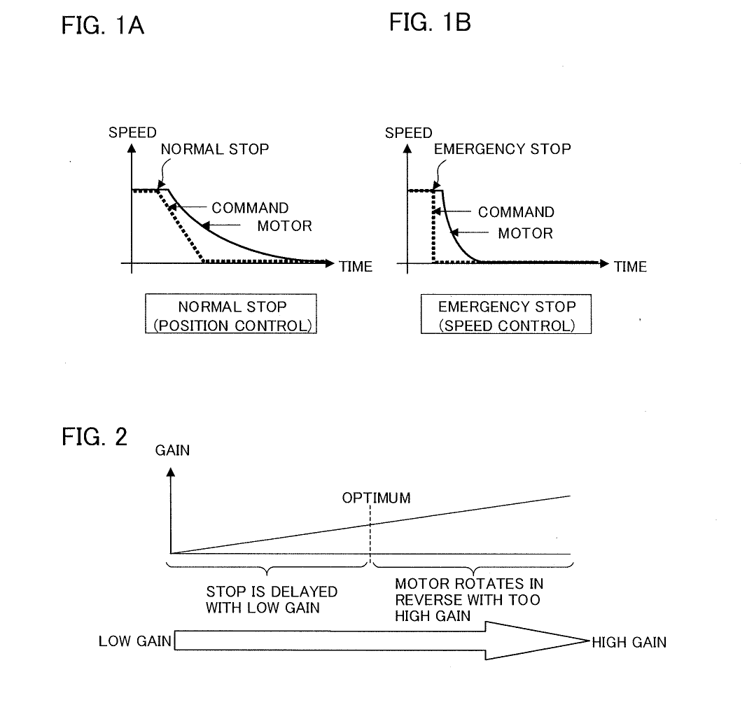

### DETAILED DESCRIPTION OF THE PREFERRED EMBODIMENTS

A numerical control device acquires stopping characteristic data of the motor at emergency stop by performing emergency stop with speed control in advance, calculates position control gain for emergency stop based on the acquired data. At emergency stop, the numerical control device switches to the position control gain for emergency stop calculated in advance, and urgently stops the motor with position control with reduced stopping distance of motor. In addition to that, when a plurality of axes are operated while the axes are interpolating, the axes can stop in the shortest distance keeping synchronization among the axes by stopping with position control.

### Embodiment Includes in Claims 1, 2

For stopping a rotating motor, high gain enables quick stopping, but too high gain causes overshoot and the motor will be rotated in reverse as shown in FIG. 2.

Therefore, in the present embodiment, emergency stop by zero speed command with speed control, as conventional emergency stopping, is performed first, and optimum position control gain is calculated based on the speed at starting of stopping and travel distance to the stopping.

At emergency stop, by switching set value of position control gain of the motor to the position control gain for emergency stop calculated at trial stopping performed in advance, emergency stop equivalent to the zero speed command in speed control become possible.

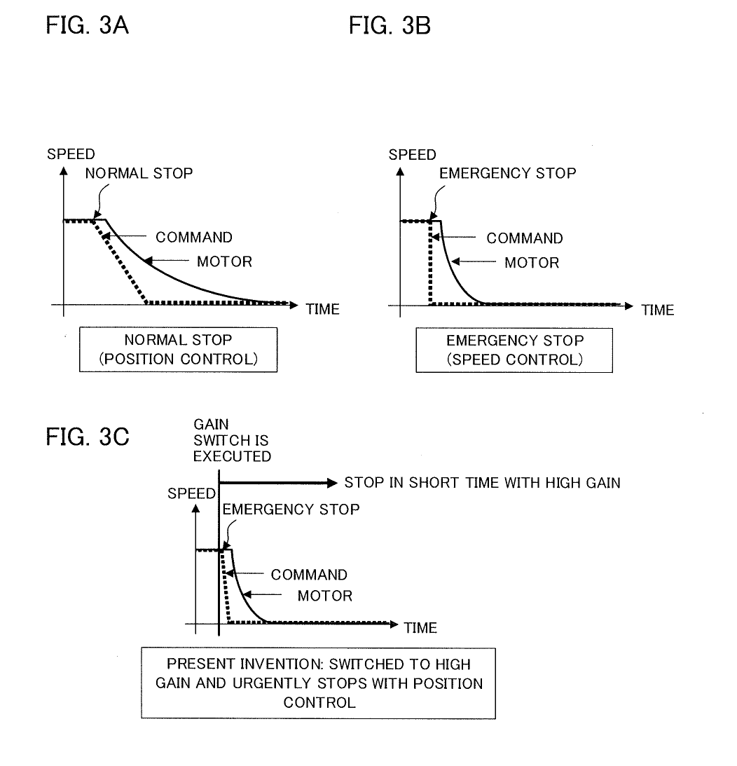

FIGS. 3A, 3B, 3C are diagrams for explaining control for switching to high gain and emergency stop. FIG. 3A is a diagram explaining normal stop with position control. FIG. 3B is a diagram explaining emergency stop with speed control. FIG. 3C is a diagram explaining emergency stop with position control with the gain switched to high gain. In FIG. 3C, by executing gain switching, high gain is set for early stop.

### (Calculation of Position Control Gain for Emergency Stop)

In the present embodiment, position control gain for emergency stop is calculated in Equation (1) below, when speed before starting of deceleration is V and movement amount from starting of deceleration to stopping is L as a result of the conventional emergency stop shown in FIG. 3B.

[position control gain for emergency stop]=V/L (1)

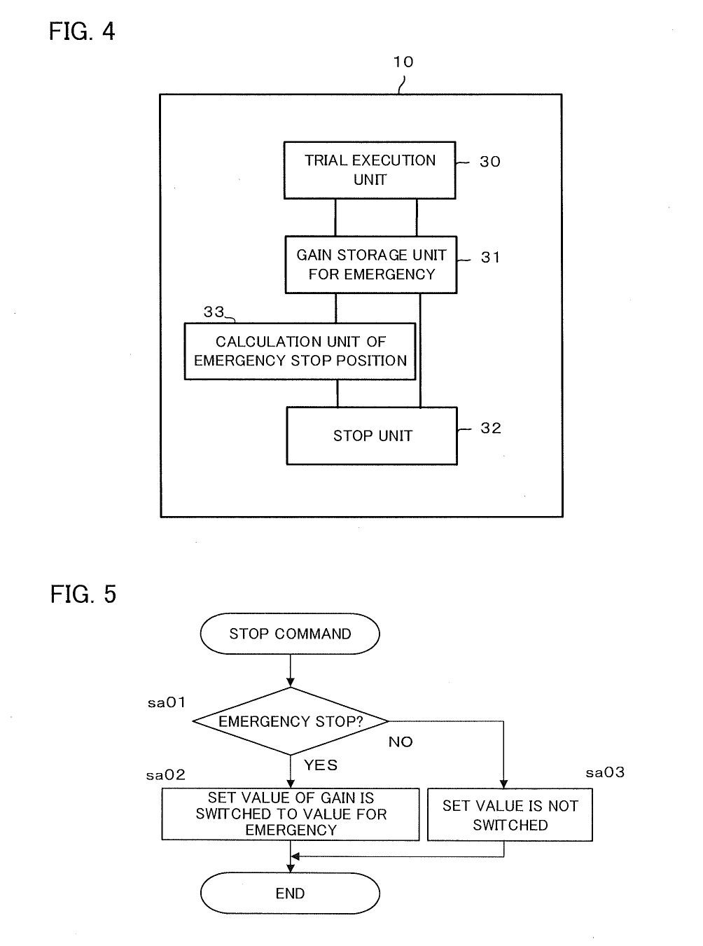

FIG. 4 is a diagram showing a control device equipped with a unit for calculating position control gain for emergency stop. A numerical control device 10 for controlling a motor to be described below includes a trial execution unit 30, an emergency gain storing unit 31, and a stop unit 32. The trial execution unit 30 calculates position control gain for emergency stop from Equation (1) using the speed V at the start of the deceleration and the movement amount L from the start of the deceleration to the stopping. The speed V and the movement amount L are physical amounts which the numerical control device 10 can acquire. The position control gain for emergency stop calculated by the trial execution unit 30 is stored in the emergency gain storing unit 31. The stop unit 32 to be executed at emergency reads the gain stored in the gain storing unit 31, and executes the stop of motor with position control for emergency stop.

### (Flowchart)

FIG. 5 is a flowchart for explaining control for switching position control gain to position control gain for emergency stop which is calculated by conventional emergency stop (with speed control) in advance. Each step will be described below.

[Step sa01] It is determined whether emergency stop is commanded or not, and the process proceeds to Step sa02 when the emergency stop is commanded, and the process proceeds to Step sa03 when the emergency stop is not commanded
[Step sa02] Set value of gain is switched to the value for emergency and the process ends.
[Step sa03] Set value of gain is not switched and the process ends.

### Embodiment Includes in Claim 3

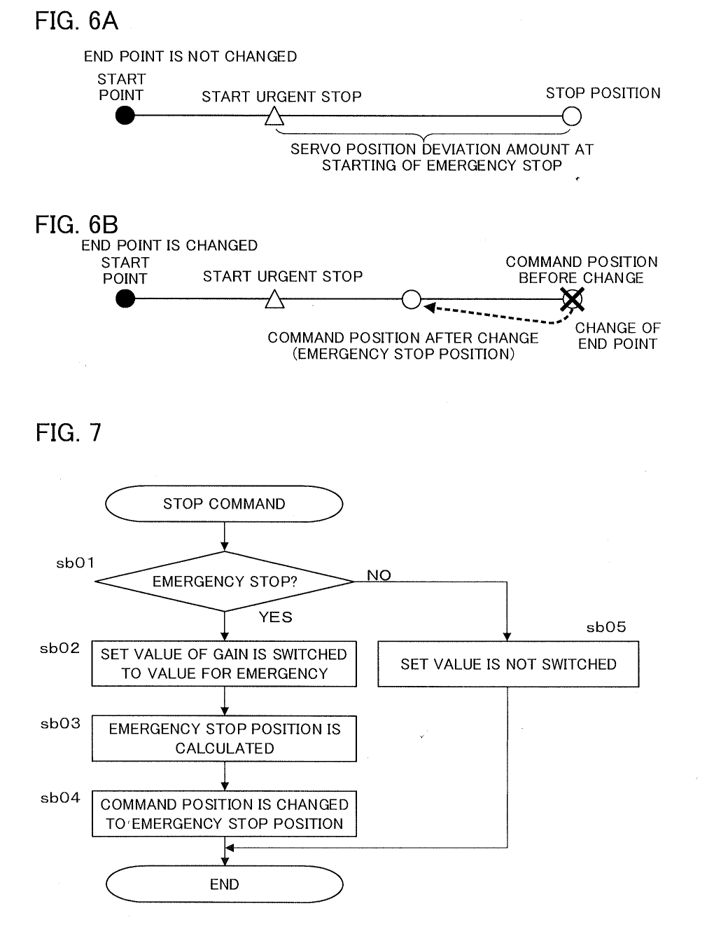

FIGS. 6A, 6B are diagrams illustrating a case in which end point, that is, stop position, is not changed when emergency stop is commanded (FIG. 6A), and FIG. 6B is a diagram illustrating a case in which end point (stop position) is changed when emergency stop is commanded (FIG. 6B).

Increased gain enables quick stop at emergency stop in position control. However, when position command is not changed when emergency stop is commanded, stopping time is shortened but the stopping distance is still long as the case where the gain is not increased, since large amount of servo position deviation amount is accumulated to be stopped by normal position control (FIG. 6A).

Therefore, emergency stop position is calculated at emergency stop, and the command end position is changed to the emergency stop position, such that the motor stops at the minimum distance to stop. This enables to stop at the same distance as in the case in which control method is switched to speed control at emergency stop and the motor stops with zero speed command. In addition to that, servo position deviation amount is zero since control method is still position control at the stopping, so the next movement can be immediately commanded (FIG. 6B).

### (Calculation of Emergency Stop Position)

Emergency stop position is calculated from the equation below.

[emergency stop position]=[speed]/[position control gain for emergency stop]+[start point of deceleration] (2)

As shown in the numerical control device 10 in FIG. 4, a calculation unit 33 of emergency stop position calculates emergency stop position by Equation (2).

Data of rotation speed of the servo motor when emergency stop is commanded may be used for the speed at the start of the deceleration. In addition to that, the data of position of each axis (rotation position of the servo motor) when emergency stop is commanded may be used for the start position of the deceleration.

### (Flow Chart)

FIG. 7 is a flowchart of control in which, when emergency stop command is executed, position control gain is switched to position control gain for emergency stop calculated by conventional emergency stop (with speed control) performed in advance, then emergency stop position is calculated based on current motor speed, and command position is changed to emergency stop position. Each step will be described below.

[Step sb01] It is determined whether emergency stop is commanded or not, and the process proceeds to Step sb02 when the emergency stop is commanded, and the process proceeds to Step sb05 when the emergency stop is not commanded
[Step sb02] Set value of gain is switched to the value for emergency and the process ends.
[Step sb03] Emergency stop position is calculated.
[Step sb04] Command position is switched to emergency stop position and the process ends.
[Step sb05] Set value of gain is not switched and the process ends.

### Embodiment Included in Claim 4

If emergency stop command is executed when a plurality of motors are interpolating and operating along command paths according to conventional control method, position control is switched to speed control and the plurality of motors individually stop without synchronization. For this reason, synchronization in position control among motors is lost and there is a risk for the axes to stop at position out of the command path.

Therefore, in the present invention, one axis among the interpolating axes is set to be a reference axis. Then command position for all axis except for the reference axis to stop keeping synchronization without deviating from the path is output. Thus emergency stop command position with which position relationship among axes is not lost at emergency stop and the axes stop without deviating from the command path.

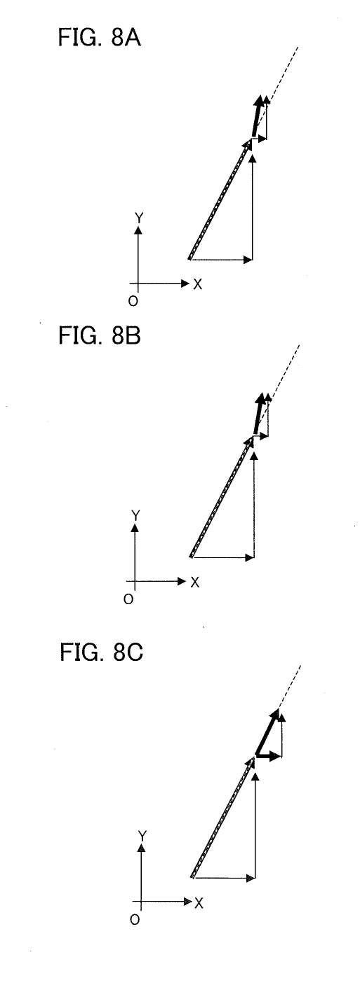

Here, using examples shown in FIGS. 8A, B, C, a case for executing emergency stop command while two axes of X axis and Y axis are interpolating and operating with position control will be described. FIG. 8A shows stopping with conventional method (speed control) and the axes do not stop on the command path. FIG. 8B shows stopping with position control according to the present embodiment, in which stop positions of each axes of X axis and Y axis are individually set and there is a possibility that each axis does not stop on the command path. FIG. 8C shows stopping with position control according to the present embodiment, in which the end points of each axis are changed based on the reference axis, and each axis can stop on the command path.

As mentioned above, the axes of X axis and Y axis independently stop since position control is not executed in conventional method (speed control) shown in FIG. 8A. As a result, there is a risk for the axes to stop at the position not on the original command path. In addition to that, when end points for each axis are set based on position control gain for emergency stop measured in advance in the present embodiment, the axes stop at the stop position similar to the position in the conventional method (speed control), so there is a possibility that the axes stop at the position no on the original command path as shown in FIG. 8B.

Therefore, when a reference axis is used of emergency stop with position control in the present embodiment, the Y axis, whose position control gain for emergency stop is lower than the gain of X axis, for example, is set to be the reference axis. End point corresponding to position control gain for emergency stop calculated in advance as in claim 3, is set for Y axis.

On the other hand, end point of X axis is determined based on the end point of Y axis such that the X axis can stop on the path keeping synchronization with the Y axis, for X axis, and the X axis urgently stops by changing position control gain for emergency stop to be same to that of Y axis. Thus, the axes can urgently stop without losing position relationship (FIG. 8C).

### (Flowchart)

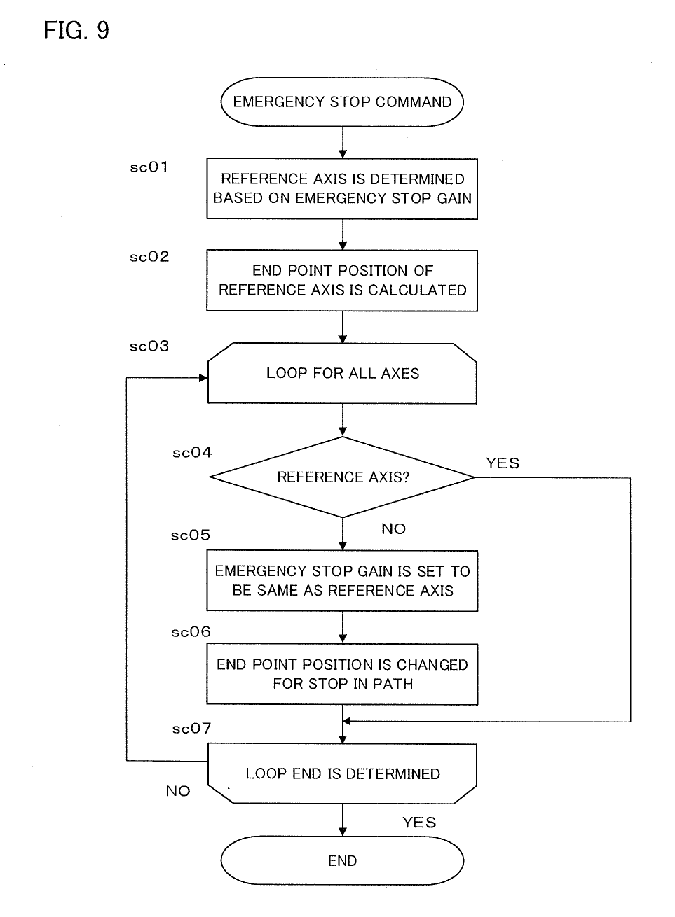

FIG. 9 is a flowchart illustrating a process of executing loop processing for all interpolating axes, changing value of position control gain for emergency stop to the same value of a reference axis except for the reference axis, and changing the end point such that the axes can stop in command paths.

If emergency stop command is executed when a plurality of motors are interpolating and operating along command paths, position control gains for emergency stop of all interpolating axes are compared to determine a reference axis, first. Next, end point of the reference axis is determined based on position control gain for emergency stop of the reference axis. Loop processing is executed for all interpolating axis, value of position control gain for emergency stop is changed to the same value as that of reference axis for all axes except for the reference axis, and end point is changed so that the axis can stop on the path. Each step will be described below.

[Step sc01] A reference axis is determined based on gain for emergency stop.
[Step sc02] Stopping position of the reference axis is calculated.
[Step sc03] Loop processing is executed for all interpolating axes.
[Step sc04] It is determined whether the axis is the reference axis or not. The process proceeds to Step sc07 when the axis is the reference axis, and proceeds to Step sc05 when the axis is not the reference axis.
[Step sc05] Gain for emergency stop is set to be same to that of the reference axis.
[Step sc06] End point position is changed for stopping on command path.
[Step sc07] It is determined whether the loop processing is completed, and the process returns to Step sc03 when the loop processing is not completed, and the process ends when the loop processing is completed.

### Specific Examples Included in Claims 1 to 4

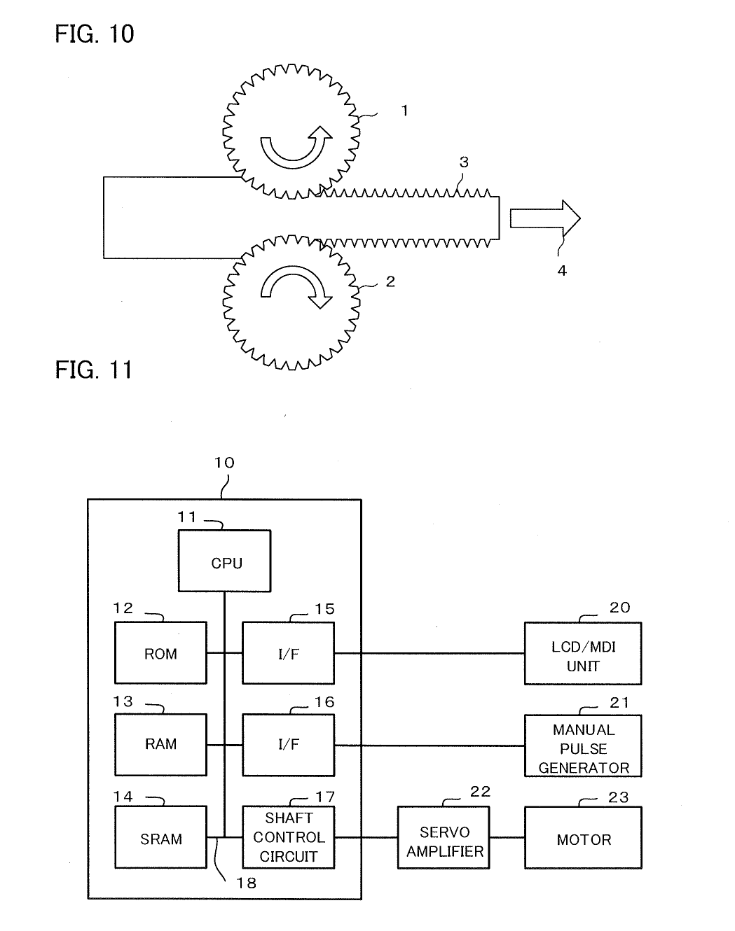

FIG. 10 is a diagram illustrating hot gear rolling of a spur gear machined by a plurality of axes. In the hot gear rolling of a spur gear, a workpiece 3 passes in the direction of the arrow 4 through gap between tools 1, 2, having tooth profile for form rolling on their peripheral part, such that a toothed wheel is formed in the workpiece 3 by rolling. A motor driving the tools 1, 2 needs to be urgently sopped when any abnormality occurs during manufacturing work of the spur gear. In addition to that, the tools 1, 2 needs to be reversely rotated to immediately return the workpiece 3 before the temperature decreases when abnormality occurs, since the workpiece 3 is machined in high temperature.

### [Prior Art]

In the conventional stopping with speed control, since each motor independently urgently stop, synchronization between the tools are disturbed, and there is a possibility that the gears are not engaged and the workpiece is damaged. In addition to that, since, when the motor is driven again with position control, accumulated servo position deviation amount needs to be cleared, and the amount cleared needs to be reflected (follow-up”) to a current position managed by a numerical control device, the workpiece is not returned immediately after the stop. Thus, there is a risk for the workpiece to be damaged or the machining tool to be broken.

### Present Application Example

On the other hand, since the motor is stopped with position control in the present application example, synchronization relationship is not lost, and gear meshing is not disturbed. In addition to that, the motor can be operated again with position control right after the stop, and the workpiece can be returned immediately.

### Example Included in Claim 5

When only one position control gain for emergency stop can be set, there is a possibility in which the motor can not stop in the shortest distance or overshoots for too high gain, dependent on workpiece weight or position of the machine. Therefore, when position control gains for emergency stop supposed in advance are stored by type and selected according to the situation at emergency stop, stopping in the shortest distance in various situation is enabled. Switching of gain will be described below.

### [Switching by Signal]

Signal determining gain to be selected is set in advance according to workpiece weight, and the signal is referred at emergency stop and position control gain for emergency stop to be switched is selected.

### [Switching by Speed]

Position control gain for emergency stop to be selected for each speed is determined by parameter or the like. At emergency stop, the speed is confirmed and position control gain for emergency stop to be switched is selected.

### [Switching by Position]

Position control gain for emergency stop to be selected for each coordinate value is determined by parameter or the like. At emergency stop, the coordinate value is confirmed and position control gain for emergency stop to be switched is selected.

Similar switching can be applied to a case using combination of the conditions mentioned above, including load, weight, position of the machine, speed, and the switching can corresponds to various patterns of the combination by measuring the parameters to be used in advance.

FIG. 11 is a diagram illustrating a numerical control device with reduced stopping distance of a motor.

The numerical control device 10 controls a main machine (not shown) of a machining tool, an industrial machine, or the like. The numerical control device 10 stores program to execute process of the flowcharts shown in FIGS. 5, 7, 9, and executes the program to decrease the stopping distance of the motor. A processor (CPU) 11 controls entire numerical control device 10. The processor (CPU) 11 reads system program stored in a ROM 12 via a bus 18, and controls entire numerical control device 10 according to the system program.

The system program stored in the ROM 12 includes various programs for processing edition mode necessary for generation and edition of the machining program and processing of reproduction for automatic operation. It should be noted that in the present description, a machining tool includes an industrial machine. A RAM 13 temporarily stores each kind of data including temporary calculation data. A SRAM 14 is backed up by a battery not shown in the figure, and works as a nonvolatile memory. Various kinds of data input by the operator using a LCD/MDI unit 20 are stored in data region of the SRAM 14 via an interface 15. In addition to that, machining program which is read in, the machining program input via the LCD/MDI unit 20, and the like are configured to be stored in the SRAM 14. The LCD MDI unit 20 consists of a display including a liquid crystal display device and a manual input device including a keyboard.

Image signal, including current position of the machining tool, alarm, parameter, image data, and the like, are sent to the LCD/MDI unit 20, and displayed on a screen of the LCD/MDI unit 20. LCD/MDI unit 20 includes a display including a liquid crystal display device and a manual input device including a keyboard.

The interface 15 receives data from the manual input device of the LCD/MDI unit 20, and sends the data to the processor (CPU) 11. An interface 16 is connected to a manual pulse generator 21, and receives pulse from the manual pulse generator 21. The manual pulse generator 21 is installed in a console panel of the machine body, and used for precisely aligning movable part of the machining tool by each axis control using distributed pulse based on manual operation.

An axis control circuit receives movement command of each axis from the processor (CPU) 11, and outputs the command to a servo amplifier 22. The servo amplifier 22 receives the command, and drives a servo motor 23 of each axis of the machining tool. The servo motor 23 of each axis includes a position and speed detector (not shown in the figure) and feeds back position data to an axis control circuit 17. Speed data can be generated by obtaining the difference of the position data. In FIG. 11, the feedback signal of position and speed is not shown.

1. A numerical control device for controlling a motor, comprising:
a stopping unit configured to stop the motor using position control gain for emergency stop corresponding to emergency stop command; wherein
emergency stop of the motor is performed with position control.

2. A numerical control device according to claim 1, wherein the position control gain for emergency stop is calculated based on speed at emergency stop and travel distance required for emergency stop when emergency stop is performed with speed control as motor control method in advance.

3. A numerical control device according to claim 1, wherein command position is changed to emergency stop position calculated from current speed and gain changed when the emergency stop is commanded.

4. A numerical control device according to claim 1, wherein nearest command position where a plurality of axes stop keeping synchronization is configured to be output, when the emergency stop is commanded during operation of the plurality of axes along commanded paths with interpolation, such that position relationship of the plurality of axes are kept at emergency stop.

5. A numerical control device according to claim 1, wherein a plurality of position control gain for emergency stop, each corresponds to a plurality of patterns with different conditions, are configured to be kept, and position control gain for emergency stop corresponding to the condition is configured to selected at emergency stop.

6. A numerical control device according to claim 2, wherein command position is changed to emergency stop position calculated from current speed and gain changed when the emergency stop is commanded

7. A numerical control device according to claim 2, wherein nearest command position where a plurality of axes stop keeping synchronization is configured to be output, when the emergency stop is commanded during operation of the plurality of axes along commanded paths with interpolation, such that position relationship of the plurality of axes are kept at emergency stop.

8. A numerical control device according to claim 3, wherein nearest command position where a plurality of axes stop keeping synchronization is configured to be output, when the emergency stop is commanded during operation of the plurality of axes along commanded paths with interpolation, such that position relationship of the plurality of axes are kept at emergency stop.

9. A numerical control device according to claim 6, wherein nearest command position where a plurality of axes stop keeping synchronization is configured to be output, when the emergency stop is commanded during operation of the plurality of axes along commanded paths with interpolation, such that position relationship of the plurality of axes are kept at emergency stop.

10. A numerical control device according to claim 2, wherein a plurality of position control gain for emergency stop, each corresponds to a plurality of patterns with different conditions, are configured to be kept, and position control gain for emergency stop corresponding to the condition is configured to selected at emergency stop.

11. A numerical control device according to claim 3, wherein a plurality of position control gain for emergency stop, each corresponds to a plurality of patterns with different conditions, are configured to be kept, and position control gain for emergency stop corresponding to the condition is configured to selected at emergency stop.

12. A numerical control device according to claim 4, wherein a plurality of position control gain for emergency stop, each corresponds to a plurality of patterns with different conditions, are configured to be kept, and position control gain for emergency stop corresponding to the condition is configured to selected at emergency stop.
